(19) United States
(12) Patent Application Publication
(10) Pub. No.: US 2012/0248147 A1
(43) Pub. Date: Oct. 4, 2012

(54) Apparatus for Dispensing a Plurality of Liquids

(75) Inventors: Ronald Peter Krom, HC Katwijk (NL); Goran Aleksijovski, HX Noordwijk (NL); Johannes Hermanus Nicolaas Post, NM Sassenheim (NL)

(73) Assignee: Fluid Management Operations, LLC, Wheeling, IL (US)

(21) Appl. No.: 13/073,310

(22) Filed: Mar. 28, 2011

(51) Int. Cl. B67D 7/06

(52) U.S. Cl. 222/135; 222/144; 222/144.5; 222/105

(57) ABSTRACT

An apparatus for dispensing a plurality of liquids, in particular colorants for paints, comprising a support, such as a turntable or a linear table, defining a plurality of positions and a plurality of containers holding a liquid, mounted on the support at the positions, and provided with a pump and/or a valve for dispensing the liquid from the container. At least some of the containers form, together with a respective liquid and pump and/or valve, a cartridge, which cartridge is releasably mounted in the apparatus.

### BACKGROUND

1. Technical Field

The invention relates to an apparatus for dispensing a plurality of liquids, in particular colorants for paints, comprising

a support, such as a turntable or a linear table, defining a plurality of positions, e.g. slots or compartments, and

a plurality of containers holding a liquid, mounted on the support at the positions, and provided with a pump and/or a valve for dispensing the liquid from the container.

The invention further relates to a cartridge to be releasably mounted in the apparatus.

2. Background of the Related Art

US 2006/0169718 relates to a dispenser apparatus including a centrally located vertically mounted column assembly. A plurality of canisters is cantilever mounted to the column assembly. Each canister has a receptacle for holding a fluid and each receptacle includes a corresponding pump for dispensing fluid held therein. The dispenser apparatus also includes a stationary dispensing station having a mechanism for selectively actuating the pump for dispensing fluid held in the receptacle. A mechanism is also provided for engaging a portion of a canister to align a pump corresponding to a receptacle to the stationary dispensing station, wherein the fluid held in the receptacle may be dispensed.

Similar apparatuses are known from WO 2010/113008, WO 2005/107933, WO 2005/039747, EP 800 858, EP 1 134 186, and EP 1 090 679. U.S. Pat. No. 2,094,702 discloses a color mixing machine comprising a plurality of containers mounted on a vertical support.

EP 1 772 710 discloses a metering cap (10) comprising a body (11) and a metering disc (15) rotatably mounted between two surfaces (20, 24) of the body. The metering disc (15) has at least one hole or cavity (18) that can be filled with a unit volume of powder through a first opening (21) in a first angular position of the metering disc. By rotation of this disc by means of a gear wheel (17) solidly attached to a drive shaft (16) and to the metering disc (15), the powder held in the cavity (18) can be discharged through a second opening (23) and an exit channel (22) in a second angular position. The metering cap is intended to be fitted on each of the powder bottles employed in a station for preparing mixtures of powders. In the description (paragraphs [0046] and [0067]) it stated that the metering cap could be used, not only for powders of any grain size but also for more or less pasty substances and even for liquids. EP 1 772 710 provides no information on how this could be effected.

It is an object of the present invention to provide an apparatus for dispensing a plurality of liquids, in particular colorants for paint, that is more operator friendly.

### SUMMARY OF THE DISCLOSURE

To this end, in the apparatus described in the preamble of this specification, at least some of the containers form, together with a respective liquid and pump and/or valve, a cartridge, which cartridge is releasably mounted in the apparatus.

Thus, the components of the apparatus that come into contact with a specific liquid, in particular colorants for paints, are integrated to form a closed, swappable module and specific liquids are no longer confined to specific locations in the apparatus.

In an embodiment, at least some of the containers and respective pump and/or valves are unitary, i.e. form a whole such the container and pump and/or valve cannot be taken apart without causing permanent damage to the cartridge.

In another embodiment the pumps are positive displacement pumps, e.g. piston pumps, gear pumps, or nutating pumps.

To reduce or prevent contact between the liquids and surrounding air, it is preferred that at least some of the containers comprise a flexible bag holding the liquid.

In an embodiment, at least some of the cartridges contain a device urging the liquid in the container towards the pump and/or valve, e.g. by a spring, pressurized gas or by squeezing the flexible bag, if present.

In another embodiment, the apparatus comprises a device for measuring, e.g. weighing, the amount of liquid that is being dispensed. Thus, at least part of the accuracy is obtained via weighing and the pumps can be kept relatively simple, which is especially relevant if the cartridge and hence the pump is disposable. Further, verification of the dispensed amounts reduces the risk of so-called miss-tints.

In principle, it is possible to weigh the (paint) can into which the liquids are dispensed. However, as in practice the weight of cans varies considerably, typically filled cans are in a range from 0.5 to 21 kilograms, and cans are often dropped onto the support, it is preferred that the apparatus comprises a weighing device for weighing the support, and thus all cartridges on it, or one or more individual cartridges, e.g. the cartridge from which a liquid is being dispensed.

In another embodiment, one or more of the positions are empty during normal use, i.e. no cartridges are present at these positions. Thus, if one of the cartridges in the apparatus is (almost) depleted, a further cartridge containing the same liquid can be placed in the empty position.

In yet another embodiment, the apparatus comprises a cover positioned over the support and the cartridges, which cover allows access to precisely one position on the support. This enables the dispenser to determine and record the positions of each of the cartridges inserted into the dispenser, without the need for e.g. a barcode or transponder.

To enhance swappability of the cartridges, it is preferred that replacing a cartridge with an identical cartridge merely requires mechanically disengaging the cartridge and subsequently mechanically engaging the replacement cartridge.

The invention also relates to an apparatus as defined in the preamble of this specification, wherein the support is a turntable and the turntable extends vertically or at an angle (α) in a range from 0° to 80° with the vertical.

In these configurations, which can also be applied in embodiments not having the swappable cartridge specified above, rotation of the table results in stirring of the contents of the containers. Thus, stirrers are in principle not required or could be replaced with static elements, such as protrusions, e.g. ridges, on the inner wall of the container.

In an embodiment, the angle (α) equals arctan(d/1) ±5°, where “d” is the average diameter and “1” is the length of the container.

In another embodiment, no movable, e.g. rotatable, stirrer is present in at least some, preferably all of the containers.

In a further embodiment, the apparatus comprises a controller, in turn provided with or connected to a memory, for operating the support and pumps and/or valves and storing for at least some of the liquids the amounts that are used per unit of time.

In a refinement, the controller is arranged to store the consumption of the liquids in the containers over a prolonged period of time, e.g. spanning the period of installation of at least two consecutive cartridges containing the same (type of) liquid.

Statistics of colorant consumption enable calculating the probability that a cartridge will need to be replaced with a new (full) cartridge in e.g. the coming day or week. Depending of the probability, the apparatus can then generate a message suggesting e.g. inserting a replacement cartridge in the apparatus, thus avoiding having to replace a cartridge during the dispensing of a recipe while a customer is waiting.

Invention further relates to a cartridge to be releasably mounted in an as described above, the cartridge comprising a container holding a liquid and a pump and/or a valve for dispensing the liquid from the container.

### BRIEF DESCRIPTION OF THE DRAWINGS

FIGS. 1 and 2 are front and side views of a dispenser according to the present invention.

FIG. 3 is a cross-section of a cartridge according to the present invention.

FIG. 4 a schematic depiction of a support as used in the dispenser shown in FIGS. 1 and 2.

The drawings are not necessarily to scale and details, which are not necessary for understanding the present invention, may have been omitted.

### DETAILED DESCRIPTION OF THE PRESENTLY PREFERRED EMBODIMENTS

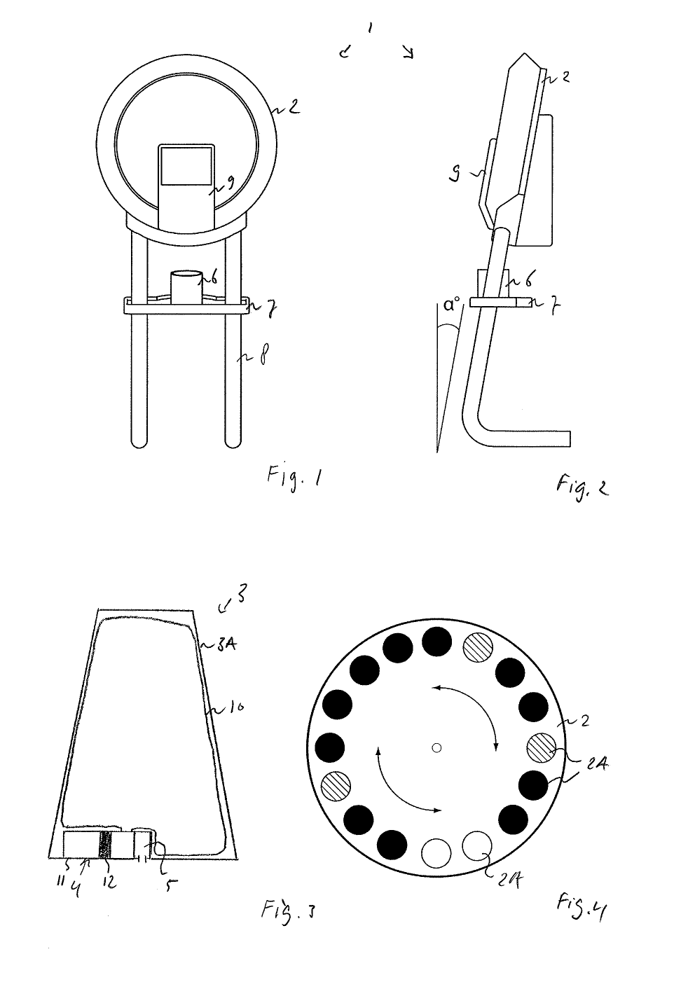

FIG. 1 shows an example of an apparatus 1 for dispensing a plurality of liquids, such as (components of) paints, paint colorants, hair dyes, shampoos, foundations, and the like. It can be used for dispensing numerous recipes and formulas of the said products and it can be located e.g. at a retailer of decorative paints, a hairdresser, or a spa, respectively.

This particular dispensing apparatus 1 is an automated version and includes an inclined turntable 2, with a plurality of cartridges 3 (hidden from view in FIGS. 1 and 2, but shown in FIG. 3) mounted along its circumference. Each cartridge 3 is provided with a pump 4 and a dispense valve 5 (FIG. 3). The turntable 2 can be rotated between discrete positions, e.g. twelve or sixteen positions 2A including a dispensing position, i.e. a position where the pump and valve of the cartridge at the dispense position are operated by means of a central actuator. Fluids are dispensed in a receptacle, in this example a bucket 6 on an adjustable shelf 7.

The apparatus 1 includes a frame or stand 8 and a controller and memory, i.c. a computer 9, for entering and storing information, such as customer data and recipes, and generating instructions for driving the turntable 2, pumps and valves.

Further information regarding suitable turntables and procedures for driving the various components, are disclosed in, for instance, European patent applications EP 800 858, EP 1 492 970, EP 1 688 652, and EP 2 198 950.

As mentioned, FIG. 3 shows a cartridge 3 comprising a flexible bag 10 holding a liquid, e.g. a colorant for paint, a piston pump 4 and a valve 5. These components are integrated to form a disposable (one-way) unit. In this example the pump comprises a cylinder 11 and a magnetic piston 12, that can be reciprocated at relatively high frequencies, e.g. 1 Hz, by a driving magnet at the dispense position.

In an example, illustrated in FIG. 4, the apparatus is intended for use with Y colorants and comprises X positions, within X>Y. During initial use, Y slots are filled with colorant cartridges and X-Y slots remain empty. In the event that a cartridge reaches a critical volume level, the controller warns the operator to place a new extra cartridge containing the same liquid in an empty slot.

From an operators perspective, it is best if the controller recommends which cartridges need to be added to the system only once a day, e.g. in the morning when the system is started up. A preferred approach is to use historic colorant consumption statistics to calculate the probability that a cartridge must be replaced that day. This implies that some cartridges may still have significant amounts of colorant in them, while others (that are used e.g. only once a week) will be completely depleted before the system recommends replacement.

The general purpose of the empty slots is to avoid the need to replace a cartridge during a dispense. The system is preferably equipped with sufficient empty slots such that it rarely occurs that the system runs out of empty slots. Using computer simulation of historic consumption, it can be estimated how many empty slots are needed for a particular customer to have sufficient empty slots. This estimate will become more accurate over time.

In a refinement, the last empty slot is reserved for colorant cartridges that are used frequently, i.e. not ‘given away’ to infrequently used colorant cartridges.

As a matter of course, this disclosure is not restricted to the above-disclosed embodiments, which may be varied in different manners within the scope of the claims.

What is claimed is:

1. An apparatus for dispensing a plurality of liquids, in particular colorants for paints, comprising
a support, such as a turntable or a linear table, defining a plurality of positions and
a plurality of containers holding a liquid, mounted on the support at the positions, and provided with a pump and/or a valve for dispensing the liquid from the container, characterized in that at least some of the containers form, together with a respective liquid and pump and/or valve, a cartridge, which cartridge is releasably mounted in the apparatus.

2. The apparatus according to claim 1, wherein at least some of the containers and respective pump and/or valves are unitary.

3. The apparatus according to claim 1, wherein the pumps are positive displacement pumps.

4. The apparatus according to claim 1, wherein at least some of the containers comprise a flexible bag holding the liquid.

5. The apparatus according to claim 1, comprising a device for measuring the amount of liquid that is being dispensed.

6. The apparatus according to claim 5, comprising a weighing device for weighing the support or one or more individual cartridges.

7. The apparatus according to claim 1, wherein one or more of the positions are empty.

8. The apparatus according to claim 1, comprising a cover positioned over the support and the cartridges, which cover allows access to precisely one position on the support.

9. The apparatus according to claim 1, wherein replacing a cartridge with an identical cartridge merely requires mechanically disengaging the cartridge and subsequently mechanically engaging the replacement cartridge.

10. The apparatus according to claim 1, wherein the support is a turntable and the turntable extends vertically or at an angle (α) in a range from 0° to 80° with the vertical.

11. The apparatus according to claim 10, wherein the angle (α) equals arctan(d/1) ±5°, where “d” is the average diameter and “1” is the length of the container.

12. The apparatus according to claim 1, wherein no movable stirrer is present in at least some the containers.

13. The apparatus according to claim 1, comprising a controller, in turn provided with or connected to a memory, for operating the support and pumps and/or valves and storing for at least some of the liquids the amounts that are used per unit of time.

14. The apparatus according to claim 13, wherein the controller is arranged to store the consumption of the liquids in the containers over a prolonged period of time, preferably spanning the period of installation of at least two consecutive cartridge containing the same liquid.

15. The apparatus according to claim 1, wherein at least some of the cartridges contain a device urging the liquid in the container towards the pump and/or valve.

16. A cartridge to be releasably mounted in an apparatus according to claim 1, comprising a container holding a liquid and a pump and/or a valve for dispensing the liquid from the container.
